(19) United States
(12) Patent Application Publication
(10) Pub. No.: US 2012/0070535 A1
(43) Pub. Date: Mar. 22, 2012

(54) APPLICATION OF FLUID BED TECHNOLOGY IN BREWING

(76) Inventor: Gerhard Kamil, Bergkirschen (DE)

(21) Appl. No.: 13/306,564

(22) Filed: Nov. 29, 2011

Related U.S. Application Data
(63) Continuation of application No. 10/476,315, filed on Aug. 11, 2004, now abandoned.

(30) Foreign Application Priority Data
May 1, 2001 (DE) 101 20 979.7
Jul. 2, 2001 (DE) 101 31 962.2

(51) Int. Cl. C12C 7/04; C12C 7/14

(52) U.S. Cl. 426/16; 426/471; 426/600; 426/618; 426/62; 99/278; 99/276; 426/436

(57) ABSTRACT

The aim of the invention is firstly to dry the wort necessary for beer production and subsequently to re-dissolve the above for the further processing, in particular, the fermentation. According to the invention, the application of fluid bed technology is particularly suitable for the production of dried wort, in particular fluid-bed drying and fluid-bed coating. The advantage of said method for the production of granulates is that no loss of quality in the wort occurs during suitable temperature changes during the drying. The granulate can thus be coated with one or several further coatings, in particular with further flavourings. Above all flavourings can be encapsulated within the dried wort, such that the above is not lost on storage and possible transport.

### STATEMENT OF RELATED APPLICATIONS

The present application is a continuation of co-pending U.S. application Ser. No. 10/476,315 filed Aug. 11, 2004, which is the U.S. National Stage of PCT/EP02/02110 filed under the terms of the PCT on Feb. 27, 2002. The disclosures of these applications are incorporated herein by reference.

### BACKGROUND OF THE INVENTION

The present invention refers to methods for producing beverages, especially brewed and/or fermented beverages, as well as to devices and plants for employing these methods.

The method of producing beer can essentially be divided into three main processes, namely the production of malt, the production of original wort and the fermentation process. This method as well as the hereby involved equipment and devices is subject of the study of brewing technology and is known to the skilled person. In this respect, it is referred to the following description of FIG. 1 and to the respective technical literature, especially to the article “125 Jahre Steinecker—Sudhaustechnologie” of H. Miedaner (“Brauwelt”, 2000, pages 799 to 805).

### SUMMARY OF THE INVENTION

The present invention has the object to improve the production of beer such that the operating processes during the production of beer are substantially simplified.

The invention is based on the idea firstly to dry the original wort necessary for beer production and subsequently to re-dissolve the above for the further processing, in particular, the fermentation. Thereby, in the present invention original wort is understood in the sense of brewing technology which, therefore, is in liquid form. Further, in the present invention it is also referred to original wort, if a different starting product is used as usually malted cereals sorts as for example barley, wheat, rye, spelt or emmer, especially other starchy basic materials such as maize, rice and/or other malted cereals sorts and/or other unmalted cereals sorts as well as sugar. However, in any case the wort must be present in liquid form.

Drying and subsequent dissolving of original wort first appears to be more laborious than the conventional production of beer. However, this approach has many advantages when producing big amounts of beer:

With the conventional approach, the whole technological process of producing wort is performed in each brewery in order to subsequently produce it to beer. This requires a local production of beer of the beer producers in a plurality of brewhouses in the respective destination countries, i.e. up to now each brewery has a brewhouse. Thereby, the whole production of wort and beer is performed on one premises. However, the technological know-how of the production of beer as a whole is contained in the production of original wort. The fermentation process does not require specific skilled knowledge.

According to the present invention, the production of original wort can be performed centralized, wherein the final product is dried original wort which can be stored and easily be transported. After transport to a fermentation plant, the dried original wort can first be dissolved in water and fermented to beer with presence of yeast. This first has the advantage that a plurality of brewhouses becomes superfluous which cause great expenses. Therefore, a centralized production of dried original wort reduces the effort substantially in view of equipment and energy, because a centralized production brings respective synergy effects. The presence of brewing technological know-how at the local fermentation plants is not decisively necessary anymore. Further, a unification of the quality of the beer production is achieved in spite of performing the final beer production at different places.

According to the present invention, the use of the fluid bed technology, i.e. fluid bed drying, fluid bed granulating, fluid bed spray granulating and/or fluid bed coating is especially suited for the production of dried original wort. The special advantages of these methods is the special suitability for the production of granulates. The granulates can thereby be coated with one or several coatings, in particular with further flavourings. Especially, however, the flavourings contained in the dried original wort can be encapsulated, such that the above do not volatilize when being stored and during a possible transport.

### BRIEF DESCRIPTION OF THE DRAWINGS

FIG. 1 shows a process diagram of a conventional beer production process,

FIG. 2 shows a process diagram of the production of wort granulate according to the present invention, and

FIG. 3 shows a process diagram of the production of beer starting from wort granulates in accordance with the present invention.

### DETAILED DESCRIPTION OF THE INVENTION

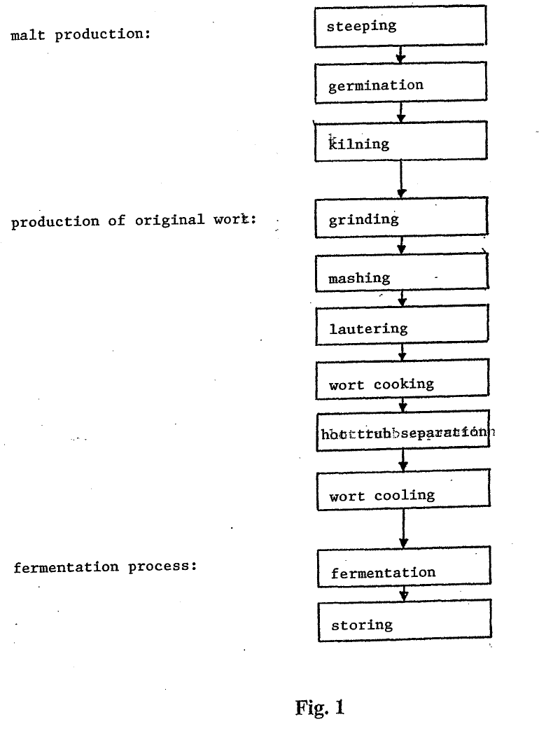

For a better understanding of the invention the process steps employed in the brewing technology as well as the usually employed equipment is first briefly discussed by means of FIG. 1. The method of beer production can essentially be divided in three main processes namely the production of malt, the production of original wort and the fermentation process.

For the production of malt, the raw barley grain is processed to malt, wherein the process steps steeping, germination and kilning is employed in the malt house. During steeping, the grain absorbs water, is supplied with oxygen and cleaned. Subsequently, germination is performed in germination plants, wherein air supply is usually achieved by ventilators, and turnover devices provide for a unitary turnover of the germination material. The purpose of malting mainly is the creation of enzymes and their controllable reactions to the malt substances. During the germination processes the germ bud causes the formation of enzymes which are able to decompose the grain substances. This process is in particular relevant for the degradation of protein and starch as well as the degradation of other substances. After the germination period which is necessary for the conversion of substances, the germination process is stopped by withdrawal of water. The skilled person denotes this process step as kilning. The withdrawal of water is usually achieved by the use of heat and air supply. Caused by the kilning, the malt gets a flavor and a color which is characteristic for the respective type, which has effect on the beer type to be produced. After the kilning, the malt usually has a water content of below 5% such that it can be stored. At the end of the malt production the malt still has the shape of grain. Besides barley, which is used as basic material for the malt production of bottom fermented beers, also other cereals sorts such as wheat, rye, spelt and emmer can be malted.

During the production of original wort, malt is usually processed to original wort under the presence of water and hops. Dependent on the desired beverage, also different sugar types as well as other starch containing basic materials such as maize, rice, other malted grain sorts and/or other unmalted cereals sorts can be processed. Further, the addition of enzyme supplements and of inorganic substances is possible. The production of wort is performed in the brewhouse which means the entity of plants and/or devices which are necessary for the production of wort. The production of wort in the brewhouse, i.e. the brewhouse process, usually consists of six partial processes, namely grinding, mashing, lautering, wort cooking, hot trub separation and wort cooling.

In order to continue with the enzymatic degradation within the malt grain which has started in the malthouse plant, the malt has to be grinded in a well defined manner. This process of grinding is usually performed in a malt mill which has the object to separate the grain encasement, the so-called husks from the residual grain. Thereby, the husks must be treated as sparing as possible for the later use as discussed below in detail. During grinding, the starch containing body is to be chopped as far as possible.

The subsequent mashing is usually performed in a mash tun and a mash kettle. Mashing is understood as dissolving the malt ingredients, in particular starch and proteins, and the degradation of high molecular organic substances in a water dissolving form by means of the enzymes of the malt. The insoluble starch is degraded to fermentable sugars as most important process during mashing. Mashing plays a central role for the production of original wort, because during this process the basis for the wort composition and therefore for the type of beer and the beer quality is ascertained. The process of mashing starts with mixing a specific amount of grist and a specific amount of brewing water, the so-called mash-liquor. For controlling the process, the parameters temperature, duration, concentration of the mash and in a low extent the concentration of the mash and in a low extent the concentration of hydrogen ions are available for the brewer. The extract solution being present at the end of mashing in the mash is called first wort.

Lautering is performed either in a lauter tun or—rarely—in a mash filter. In general, lautering is understood as the separation of the dissolving contents of the mash, namely the wort from the insoluble contents, the so-called spent grain. The spent grain mainly consists of husks and proteins gained during grinding, and further of starch and mineral components. For the lautering, the whole mash is pumped into the lauter tun. Above the tun base, the lauter tun has a sieve bottom, the so-called false bottom. Thereon, the spent grain lays down, while the wort gets through the screen slits from the lauter tun into the wort kettle, which is usually performed by pumping. The spent grain forms a filter layer for the wort to be lautered. Roughly, the process of lautering can be divided into two steps: The deduction, i.e. the pumping of the extract solution being present in the mash, namely the first wort, and the sparging of the spent grain which still contains extract, by means of hot brewing water, the so-called sparging water. In the recent past, also other separating techniques have become known.

The wort cooking is performed in a wort kettle. During the process of cooking, hops or hop products are added, but also the addition of sugar is sometimes performed in practice. The hopping gives the wort and, with that, the beer which is produced later by fermentation, its typical bitter taste. Sugar is added in order to increase the proportion of fermentable and/or unfermentable extract in the wort solution. After the wort cooking, the so-called original wort is given. Characterizing for the original wort is the original wort content. The original wort content is the percentage of the substances which are dissolved in the wort prior to fermentation, such as malt sugar, proteins, vitamins, trace elements and flavourings. The original wort content is measured in % Plato or formerly in ° Plato, respectively. Approximately one third of the original wort content is usually transformed by yeast during fermentation into alcohol, which is expressed in weight percent. Therefore, for example a wort of twelve percent results in an alcohol content of about four weight percent. However, there are also methods in which a very high percentage extract containing wort is produced in the brewhouse plant, which is subsequently adjusted after fermentation by thinning down to a beer having a specific alcohol content.

With wort cooking, the following objects are achieved: evaporating water for adjusting the original wort content, separating high-molecular protein (the so-called break), inactivating the enzymes for fixing the wort composition, sterilizing of wort, isomerization of the hop substances, formation of flavourings (the so-called Maillard reaction) and removal of undesired flavourings. These objects are all achieved by the effect of heat during wort cooking.

After finalizing the wort cooking, the hot trub break separation is performed usually in a whirlpool, wherein the hot trub contained in the original wort is separated from the remaining original wort. The hot trub consists mainly of proteins which have been coagulated, i.e. agglomerated by the effect of heat during the wort cooking. Further, the hot trub contains polyphenols and other suspended contents. In the whirlpool, the centrifugal effect is used by means of pumping-in in tangential direction. The hot trub agglomerates in the shape of a cone on the center of the bottom of the whirlpool. The such separated original wort is subsequently pumped away. Instead of a whirlpool, also other separating systems can be used.

The last partial process in the brewhouse plant is the wort cooling in which the original wort is cooled down from almost cooking temperature to the so-called pitching temperature of for example 6° C. which is usually performed by a heat exchanging system. The cooled wort is well ventilated. Cooling is necessary prior to the fermentation in order to allow the addition of yeast which can only survive at low temperatures. Prior to the subsequent addition of yeast, the so-called pitching, the wort is called pitching wort. Directly after the addition of yeast, the pitching wort is then called beer or green beer. Now, the main fermentation of the cooled original wort is performed in a fermenter. The yeast added in the wort is able to start the alcoholic fermentation. Thereby, sugar molecules are transformed in biochemical processes into alcohol, CO₂ and up to 300 volatile and non-volatile co-substances as well as heat which has to be dissipated by cooling. At the beginning of the fermentation the yeast needs for proliferating a sufficient supply of oxygen which is achieved by ventilation after the wort cooling. The main fermentation is finished when the major part of the fermentable extract has been fermented. Thereafter a further cooling and a separation may follow. Subsequently, storing and maturation of the beer follows under slightly increased pressure, the so-called bunging pressure, usually in highly cooled storage tanks. Thereby, the remaining fermentable extract is fermented as far as possible. By means of the bunging pressure as well as by the low storing temperature, e.g. 1° C., the CO₂ content of the beer is fixed. Further, storing of the beer results in a determination of the beer and a certain chemical and physical stability of the beer.

At the end of storing, the beer has a turbidity which is usually removed by a so-called Kieselghur filtration. Subsequently, a so-called PVPP stabilization may follow for achieving a long storage life. Further, an additional carbonation of the beer may be performed. The beer then comes into a pressure tank. From there, it is filled into bottles, cans, barrels or the like by maintaining the pressure. Prior to the filling process a pasteurization may follow for achieving a long storage life of the beer.

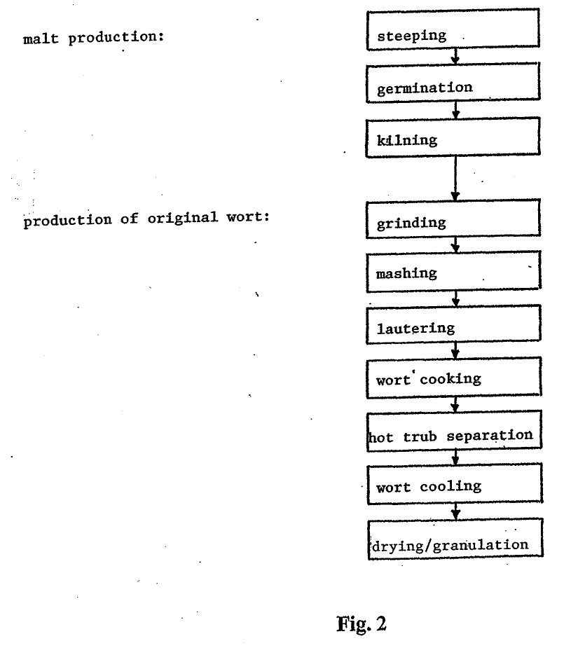

In FIG. 2 the process of the production of dried original wort, in particular original wort granulate according to the present invention is shown. The production of original wort which is present in liquid shape, is identical with the conventional production of original wort as described above. Insofar, it is therefore referred to the discussion concerning FIG. 1. Wort cooling is not necessary anymore but may still be performed. Thereafter, drying of the original wort is performed so that the dried original wort is present especially in the shape of granulate, dry substance or powder, which can be transported in a manner which is by far easier compared to original wort which mainly consists of water.

Thereby the use of the fluid bed technology, namely fluid bed drying, fluid bed granulation, fluid bed spray granulation and/or fluid bed coating, is in particular suitable. The special advantage of the fluid bed technique is on the one hand its special suitability for the production of granulates. More important, it turned out on the other hand that with the fluid bed technique there is no loss of quality or only a slight loss of quality of the original wort in case of a suitable course of the temperature, especially with a temperature of the fluid bed of 70 to 80° C.

Further, the granulates may be coated with one or several further coatings, especially with further flavourings. In particular, however, the flavourings contained in the dried original wort can be encapsulated such that they do not evaporate during storage or during a possible transport. A further advantage is the better handling, especially the better suitability for storage. Compared to the conventional basic substances the conveying and flow behavior as well as dust-free behavior of the granulates is improved. The main waste products of the wort production, the so-called spent grain, do not incur at decentral locations with the use of the invention which results in corresponding synergy effects.

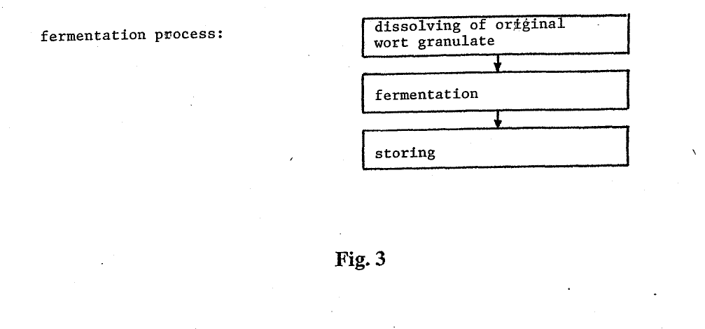

In FIG. 3 the process of the production of beer starting from dried original wort according to the present invention is shown. The dried original wort is first dissolved in water. Thereby, discontinuously operating dissolving techniques, especially the batchwise operating dissolving tank technique may be employed, but also continuously operating dissolving techniques, may be used, especially dissolving techniques in the field of the production of non-alcoholic soft drinks for dissolving crystal sugar.

The such regained original wort may be subjected to a thermal treatment or a treatment with ultraviolet light in order to sterilize or pasteurize the regained original wort prior to the addition of yeast.

The regained original wort is adjusted to a temperature which is suitable for the addition of yeast. Then the conventional fermentation process follows. Therefore, it is insofar referred to the above discussion concerning FIG. 1.

With the present invention, a continuous beer production is possible. Previous attempts aimed at achieving a continuous beer production failed in that the process in the brewhouse plant can only be operated discontinuously, namely batchwise. Contrary to that, a continuously operating fermentation is already possible according to the state of the art which, however, cannot be efficiently employed due to the discontinuously operating brewhouse plant process. According to the present invention, the original wort granulate can be stored at a fermentation plant especially in silos such that a plant for continuous fermentation can continuously be supplied with re-dissolved original wort. Thus, an efficient utilization of a continuous fermentation plant is possible. Furthermore, there is the problem with the discontinuously operating brewhouse plant process that the extract content of the liquid original wort is not unitary because of so-called first and last runnings of water. These first and last runnings of water are necessary to deliver the liquid original wort completely to the fermentation tanks without loss of original wort in the piping system. This essential disadvantage is not the case with a continuously operating re-dissolution of original wort granulate such that a continuously operating fermentation plant can be supplied with re-dissolved original wort with unitary extract content, because first and last runnings are not necessary.

Further, it is possible with the present invention to recover the water necessary for the brewhouse process during drying of the original wort and to recycle this water to the brewhouse process for the preparation of a new brew after a conditioning, if necessary. Thus, not only the necessary water amounts can be reduced with the central production of original wort, but also the required energy can be decreased in essential extent.

In order to optimize the energy required for drying or granulating the liquid original wort, it is further suggested according to the present invention to use a vacuum evaporator between the whirlpool and the fluidized bed plant. Vacuum evaporators are based on the principle that with a reduction of pressure the distillation point decreases significantly. With that, the distillation point of water can be reduced to 35° to 45° C. with a pressure of about 0 bar. In the first evaporation step energy is only necessary for the operation of the vacuum pump by which water vapor is removed. Thus, a significant amount of water can be removed from the liquid original wort with only low requirement of energy. Furthermore, undesired easily volatile flavourings are removed. In further evaporation steps an additional supply of heat energy is necessary whereas attention should be paid that the wort temperature remains below about 80° C. in order to avoid a loss of quality of the concentrated wort.

Further, a vacuum evaporator can also be used for cooking wort in order to achieve the main purpose of wort cooking, namely the removal of water of usually about 8% in an energy saving manner. According to the conventional approach, the wort is cooked 60 to 90 minutes in order to achieve a defined extract content by means of generating steam, and in order to remove easily volatile undesired flavourings. This process can be significantly reduced by means of a vacuum evaporator such that the supplied energy for the wort cooking can be correspondingly highly reduced.

1-30. (canceled)

31. Method for producing dried and encapsulated original wort free of carrier for use in production of brewed beverages, comprising
producing liquid original wort,
and
fluid bed processing the liquid original wort to produce a dried original wort granulate having a wort solids content of at least 95% by weight.

32. Method according to claim 31, further comprising encapsulating the dried original wort granulate by fluid bed processing to conserve flavor.

33. Method according to claim 31 or 32, further comprising applying flavorings to the dried original wort granulate.

34. Method according to claim 33, wherein the flavorings comprise at least one of sugar compositions, hops flavors and yeast.

35. Method according to claim 31 or 32, wherein the liquid original wort comprises water and the method further comprises withdrawing water from the liquid original wort by vacuum evaporation.

36. Method according to claim 31 or 32, further comprising producing the liquid original wort by the following steps:
conditioning brew water,
subdividing malt by grinding,
mashing for dissolving malt content substances in the brew water and for degradation of high-molecular, organic substances in a water soluble form by enzymes of the malt, whereby a mash is produced,
lautering for separating soluble contents of the mash from insoluble contents,
wort cooking for evaporating water for adjusting an original wort content, separating high-molecular protein, inactivating the enzymes for fixing composition of the original wort, sterilizing the original wort, isomerization of hops bitter substances, formation of flavorings and removal of undesired flavorings,
and
hot trub separation for separating hot trub contained in the original wort.

37. Method according to claim 36, wherein the evaporating of water comprises vacuum evaporation during wort cooking.

38. Method according to claim 36, wherein the evaporating of water comprises vacuum evaporation at the end of wort cooking.

39. Method according to claim 36, wherein at least one of the following cereals or substances is used as starting material for production of the original wort or the malt: barley, wheat, rye, spelt, emmer, maize, rice, sorghum, other malted or unmalted cereals and sugar.

40. Method according to claim 31 or 32, wherein at least one of highly concentrated beer wort, sugar, cereal flour, hops, hops compounds and flavorings is used as germ bud for the production of dried original wort granulate.

41. Method according to claim 31 or 32, wherein the dried original wort has a water content of not more than 5 weight percent.

42. Method according to claim 31 or 32, wherein the dried original wort has a water content of not more than 2 weight percent.

43. Method according to claim 31 or 32, wherein the dried original wort has a water content of not more than 1 weight percent.

44. Method according to claim 31 or 32, wherein water recovered during the drying or granulating is recycled for preparation of an additional quantity of the beverage.

45. Apparatus for producing dried original wort for use in production of brewed beverages, comprising
a wort kettle for cooking of original wort,
a whirlpool for hot trub separation for separating the hot trub contained in the original wort, and
fluid bed apparatus for drying the original wort to form a dried granulate thereof suitable for encapsulating for conserving flavor.

46. Apparatus according to claim 45, further comprising:
a brew water conditioning plant for providing brew water,
a grinding mill for subdividing malt,
a mash tun or a mash kettle for dissolving malt content substances in the brew water and for degradation of high-molecular organic substances in a water soluble form by enzymes of the malt, whereby a mash is produced, and
a lauter tun for separating soluble parts of the mash from insoluble parts.

47. Apparatus according to claim 46, further comprising a vacuum evaporator which is arranged at the wort kettle for the partial vacuum evaporation of cooked original wort.

48. Apparatus according to claim 46 or 47, further comprising apparatus for recycling water which has been recovered during the drying or granulating.

49. Granulate produced by a method according to claim 31 or 32.

50. Method for the production of brewed beverages, comprising dissolving granulate according to claim 49 in brew water thereby to produce liquid original wort.

51. Method according to claim 50, further comprising fermenting the original wort.

52. Method according to claim 51, wherein the fermenting is carried out in a continuous fermentation plant.

53. A method for producing dried and encapsulated original wort that is free of a carrier comprising the steps of:
providing liquid original wort that includes water,
removing at least a portion of the water from the original liquid wort, and
subjecting the resulting liquid original wort to fluidized bed granulation to obtain dried original wort granulate, wherein the granulate contains not more that 5% water on a weight basis.
